(19) United States
(12) Patent Application Publication
(10) Pub. No.: US 2025/0026053 A1
(43) Pub. Date: Jan. 23, 2025

(54) INJECTION MOLDING DEVICE AND INJECTION MOLDING METHOD FOR FIBER-REINFORCED RESIN

(71) Applicants: HONDA MOTOR CO., LTD., Tokyo (JP); THE JAPAN STEEL WORKS, LTD., Tokyo (JP)

(72) Inventors: Masatoshi KOBAYASHI, Saitama (JP); Hideki CHIBA, Hiroshima (JP); Mitsuhide UMEDA, Hiroshima (JP); Daisuke KUNIHIRO, Hiroshima (JP)

(21) Appl. No.: 18/752,812

(22) Filed: Jun. 25, 2024

(30) Foreign Application Priority Data
Jul. 18, 2023 (JP) 2023-117034

(51) Int. Cl. B29C 45/00; B29C 45/18

(52) U.S. Cl. CPC B29C 45/0005; B29C 45/1866

(57) ABSTRACT

Provided is an injection molding device for fiber-reinforced resin including: a heating cylinder for melting resin; a screw which is inserted in the heating cylinder; a resin feeder for feeding the resin into the heating cylinder; a long fiber feeder for feeding a long fiber into the heating cylinder; and an assister which assists in contact between the resin melted by the heating cylinder, and the long fiber fed into the heating cylinder.

This application is based on and claims the benefit of priority from Japanese Patent Application No. 2023-117034, filed on 18 Jul. 2023, the content of which is incorporated herein by reference.

### BACKGROUND OF THE INVENTION

### Field of the Invention

The present invention relates to an injection molding device for fiber-reinforced resin, and injection molding method for fiber-reinforced resin.

### Related Art

Conventionally, a direct injection molding machine has been known which directly charges resin and long fibers into a heating cylinder (heating barrel), then melt kneads and injection molds, without melt kneading the resin and long fibers in advance.

Japanese Unexamined Patent Application, Publication No. 2022-138851 describes a manufacturing apparatus for fiber-reinforced resin molded products having a heating barrel, a screw inserted inside of the heating barrel, an injection part provided on a tip side of the screw, a resin feeding part for feeding a matrix resin into the heating barrel, a long fiber feeding part for feeding long fibers into the heating barrel, and a short fiber feeding part for feeding short fibers which are shorter than the long fibers into the heating barrel. Herein, in the manufacturing apparatus for fiber-reinforced resin molded products, the short fiber feeding part is closer to the rear end of the screw than the long fiber feeding part.
Patent Document 1: Japanese Unexamined Patent Application, Publication No. 2022-138851

### SUMMARY OF THE INVENTION

However, with the manufacturing apparatus for fiber-reinforced resin molded products described in Japanese Unexamined Patent Application, Publication No. 2022-138851, the plurality of fibers hardly come into contact with the resin which has been melted by the heating barrel, and thus the productivity may decline along with the amount of waste material increasing.

The present invention has an object of providing an injection molding device for fiber-reinforced resins and an injection molding method for fiber-reinforced resins capable of improving productivity along with reducing the amount of waste materials.

According to a first aspect of the present invention, an injection molding device for fiber-reinforced resin, includes: a heating cylinder for melting resin; a screw which is inserted in the heating cylinder; a resin feeder for feeding the resin into the heating cylinder; a long fiber feeder for feeding a long fiber into the heating cylinder; and an assister which assists in contact between the resin melted by the heating cylinder, and the long fiber fed into the heating cylinder.

According to a second aspect of the present invention, in the injection molding device for fiber-reinforced resin as described in the first aspect, the long fiber feeder is provided to a downstream side of the resin feeder.

According to a third aspect of the present invention, in the injection molding device for fiber-reinforced resin as described in the first or second aspect, the long fiber feeder feeds a plurality of the long fibers into the heating cylinder.

According to a fourth aspect of the present invention, in the injection molding device for fiber-reinforced resin as described in the third aspect, the assister sprays adhesive to the plurality of the long fibers fed into the heating cylinder.

According to a fifth aspect of the present invention, in the injection molding device for fiber-reinforced resin as described in the third aspect, the assister ejects a hot-melt adhesive to a part of the plurality of the long fibers fed into the heating cylinder.

According to a sixth aspect of the present invention, in the injection molding device for fiber-reinforced resin as described in any one of the first to third aspects, the assister ejects compressed air onto the long fiber fed into the heating cylinder.

According to a seventh aspect of the present invention, in the injection molding device for fiber-reinforced resin as described in any one of the first to third aspects, the assister guides the long fiber fed into the heating cylinder by a guide plate.

According to an eighth aspect of the present invention, in the injection molding device for fiber-reinforced resin as described in any one of the first to third aspects, the assister suctions the long fiber to assist in contact with resin melted by the heating cylinder.

According to a ninth aspect of the present invention, in the injection molding device for fiber-reinforced resin as described in any one of the first to third aspects, a rod-like member capable of detaching the long fiber is provided to the long fiber feeder, and
the assister causes a rod-like member to which the long fiber has attached to move and assists contact with resin melted by the heating cylinder.

According to a tenth aspect of the present invention, in the injection molding device for fiber-reinforced resin as described in any one of the first to ninth aspects, a conveying member for conveying the long fiber is provided to the long fiber feeder.

According to an eleventh aspect of the present invention, an injection molding method for fiber-reinforced resin includes the steps of: feeding and melting resin into a heating cylinder in which a screw is inserted; feeding a long fiber into the heating cylinder; and assisting contact between resin melted by the heating cylinder and the long fiber fed into the heating cylinder.

According to the present invention, it is possible to provide an injection molding device for fiber-reinforced resins and an injection molding method for fiber-reinforced resins capable of improving productivity along with reducing the amount of waste materials.

### BRIEF DESCRIPTION OF THE DRAWINGS

FIG. 1 is a schematic drawing showing an example of an injection molding machine for fiber-reinforced resin of the present embodiment;

FIG. 2 is a partially enlarged cross-sectional view of the injection molding machine for fiber-reinforced resin in FIG. 1;

FIG. 3 is a cross-sectional view for explaining function of an adhesive sprayer in FIG. 2;

FIG. 4 is a cross-sectional view for explaining function of an adhesive sprayer in FIG. 2;

FIG. 5 is a partially enlarged cross-sectional view showing a modified example of the injection molding device for fiber-reinforced resin in FIG. 1;

FIG. 6 is a cross-sectional view for explaining function of a hot-melt adhesive ejector in FIG. 5;

FIG. 7 is a cross-sectional view for explaining function of a hot-melt adhesive ejector in FIG. 5;

FIG. 8 is a cross-sectional view for explaining function of a hot-melt adhesive ejector in FIG. 5;

FIG. 9 is a partially enlarged cross-sectional view showing a modified example of the injection molding device for fiber-reinforced resin in FIG. 1;

FIG. 10 is a partially enlarged cross-sectional view showing a modified example of the injection molding device for fiber-reinforced resin in FIG. 1;

FIG. 11 is a partially enlarged cross-sectional view showing a modified example of the injection molding device for fiber-reinforced resin in FIG. 10;

FIG. 12 is a partially enlarged cross-sectional view showing a modified example of the injection molding device for fiber-reinforced resin in FIG. 1; and

FIG. 13 is a partially enlarged cross-sectional view showing a modified example of the injection molding device for fiber-reinforced resin in FIG. 12.

### DETAILED DESCRIPTION OF THE INVENTION

Hereinafter, embodiments of the present invention will be described while referencing the drawings.

### (Injection Molding Device for Fiber-Reinforced Resin)

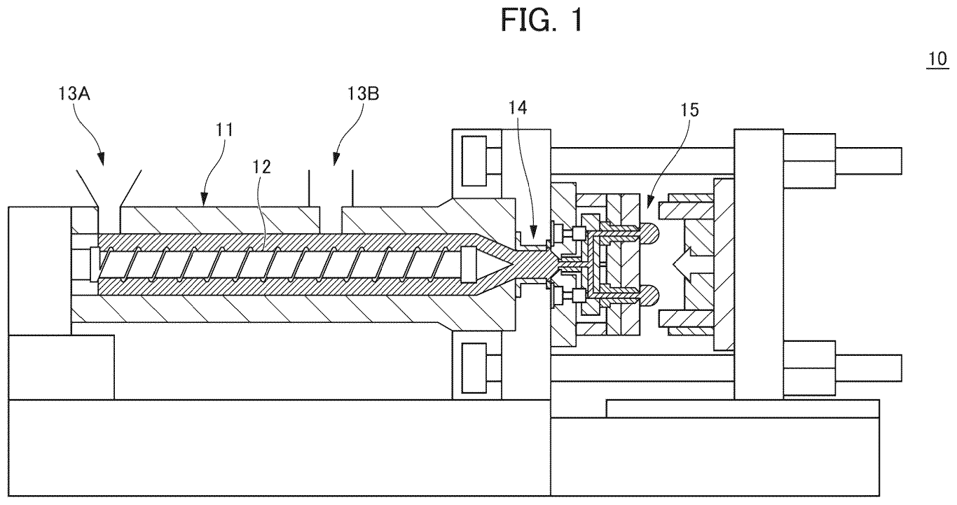

FIG. 1 shows an injection molding machine 10 as an example of an injection molding device for fiber-reinforced resin according to the present embodiment.

The injection molding machine 10 is a direct-injection molding machine which includes a heating cylinder 11 for melting resin, and a screw 12 which is inserted into the heating cylinder 11. A hopper 13A serving as a resin feeder that feeds the resin into the heating cylinder 11, and a feed box 13B serving as a long fiber feeder that feeds a plurality of long fibers into the heating cylinder 11 are installed to the heating cylinder 11. Herein, the resin melted in the heating cylinder 11 is conveyed from the upstream side to the downstream side of the heating cylinder 11 by the rotation of the screw 12. It should be noted that the feed box 13B is provided on the downstream side of the hopper 13A; however, so long as it is possible to bring the long fibers fed into the heating cylinder 11 into contact with the resin melted in the heating cylinder 11, the feed box 13B is not necessarily provided on the downstream side of the box 13A. In addition, a single long fiber may be fed from the feed box 13B. Furthermore, short fibers may be fed together with the resin from the hopper 13A.

It should be noted that the injection molding machine 10 further includes: a nozzle (injection port) 14 for injecting molten kneaded matter (fiber-reinforced resin) produced by the heating cylinder 11; and a mold 15 for molding the molten kneaded matter injected from the nozzle 14. Herein, in the vicinity of the nozzle 14 of the heating cylinder 11, a substantially conical region capable of housing a tip part of the screw 12 is formed. The mold 15 is configured from a fixed mold and a mobile mold.

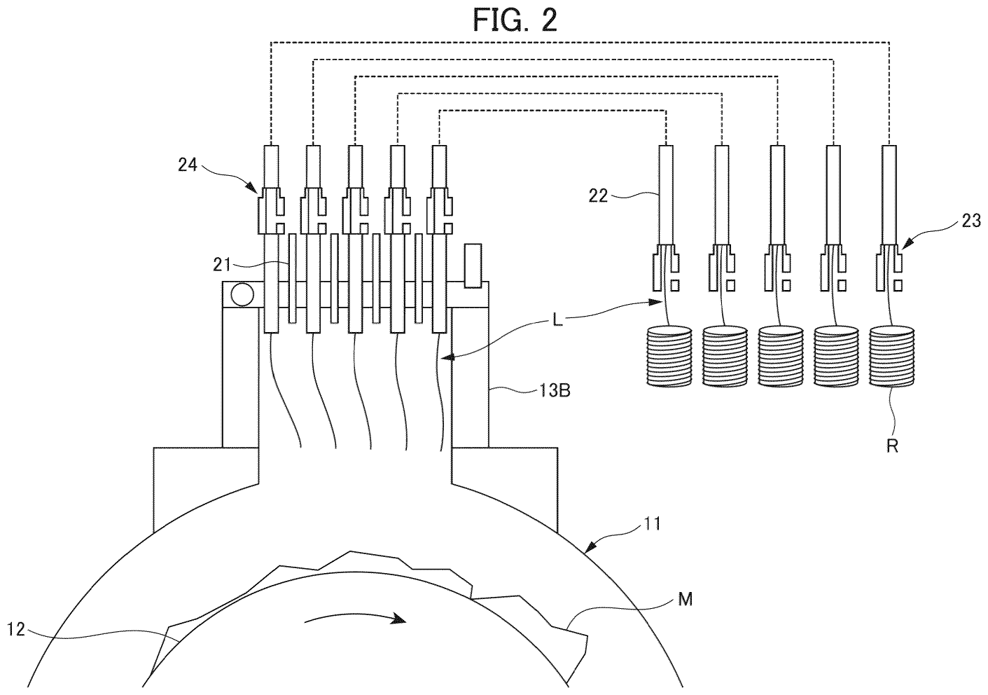

In the injection molding machine 10, as shown in FIG. 2, adhesive sprayers 21, which serve as assisters which assist in the contact between the molten resin M which has been melted by the heating cylinder 11, and the long fibers L fed into the heating cylinder 11, are installed on an upper surface of the feed box 13B. The adhesive sprayers 21 spray the adhesive A onto the long fibers L. As a commercial product of the adhesive sprayer 21, for example, the automatic spray gun SGA-3 series (manufactured by Anest Iwata) can be exemplified.

The injection molding machine 10 includes a plurality of tubes 22 which guide a plurality of long fibers L drawn out from a plurality of rovings R to the feed box 13B, and the adhesive sprayers 21 are arranged between adjacent tubes 22 of the feed box 13B. At this time, compressed air supplies 23 and 24 are respectively installed on the upstream side and downstream side of the plurality of tubes 22. The compressed air supplies 23 and 24 are each conveying members which supply compressed air to convey the long fibers L vertically upwards and vertically downwards. As a commercial product for the compressed air supplies 23 and 24, for example, a vacuum flow (manufactured by SMC) can be exemplified.

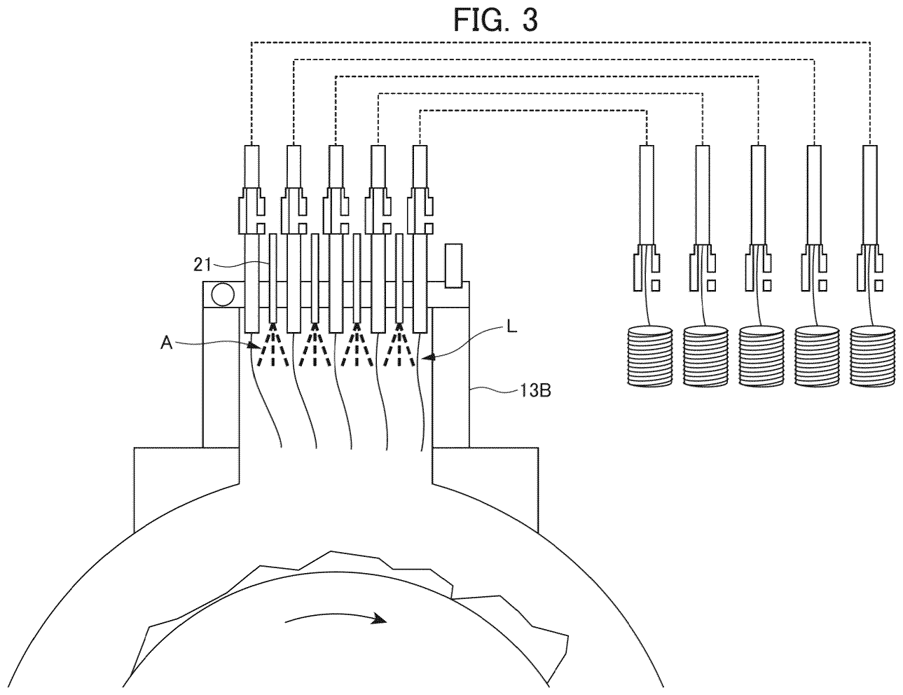

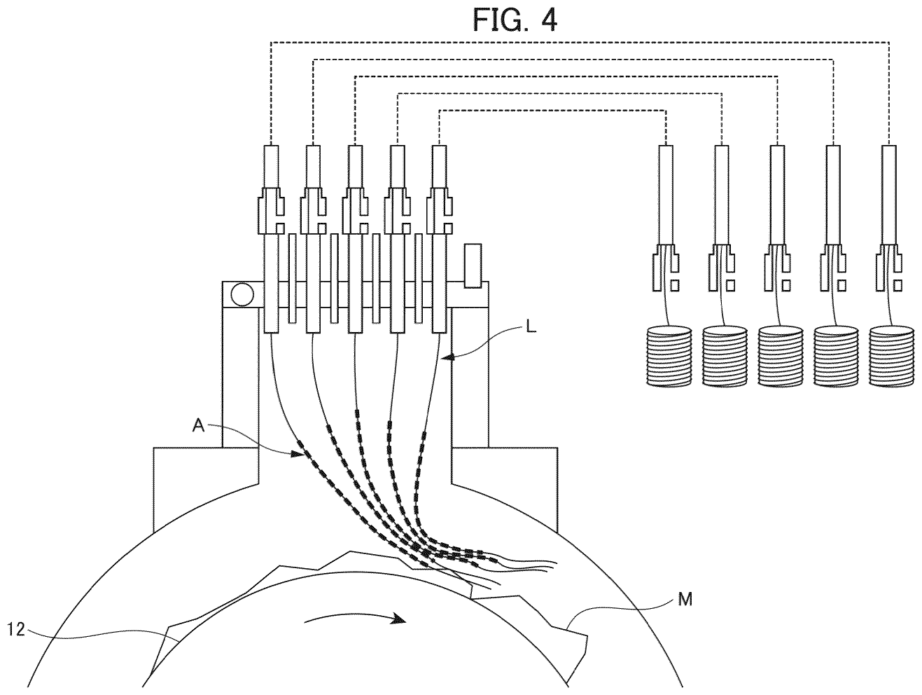

As shown in FIG. 3, when the adhesive sprayer 21 sprays the adhesive A onto the plurality of long fibers L fed in the heating cylinder 11, tackiness is imparted to the surface of the long fibers L. As a result thereof, as shown in FIG. 4, the plurality of long fibers L adhere, and then come into contact with the molten resin M attached to the screw 12, and resultingly wind around the screw 12.

If the adhesive sprayer 21 is not installed in the injection molding machine 10, the plurality of long fibers L will hardly contact with the molten resin M attached to the screw 12, and the productivity may decline along with the amount of waste material increasing.

In addition, in the injection molding machine 10, in the case of the compressed air supplies 24 not being installed on the downstream side of the plurality of tubes 22, for example, after rotation of the screw 12 is temporarily stopped, and a plurality of the long fibers L are fed into the heating cylinder 11 by manual operation, the rotation of the screw 12 is restarted, and the plurality of long fibers L are wound around the screw 12. At this time, it is necessary to repeat the manual operation until all of the long fibers L fed into the heating cylinder 11 wind around the screw 12, and thus the productivity declines, along with the amount of waste materials increasing.

So long as it is possible for the adhesive A to spray onto the long fibers L and impart tackiness to the surface of the long fibers L, the adhesive A is not particularly limited. As commercial products for the adhesive A, for example, Super G Spray Z (manufactured by Konishi Co.) and RQ-NVN2 (manufactured by Aica Kogyo Co.) can be exemplified.

The resin constituting the molten resin M is not particularly limited; however, polyimides can be exemplified as the resin.

The fibers constituting the long fibers L and short fibers are not particularly limited; however, glass fibers, carbon fibers and aramid fibers can be exemplified.

It should be noted that the fibers constituting the long fibers L and short fibers may be the same or may be different.

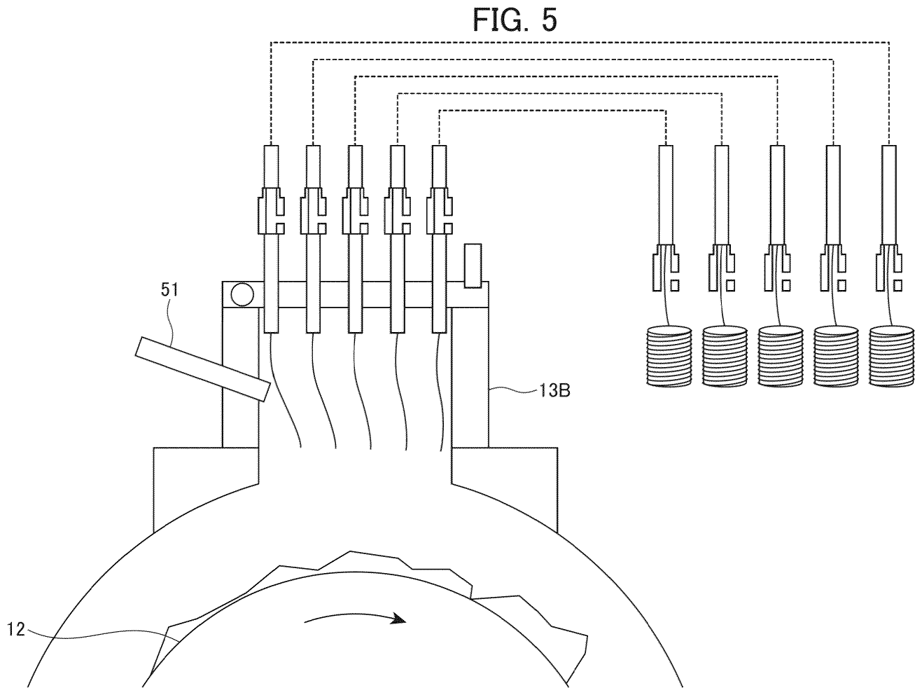

In the injection molding machine 10, instead of installing the adhesive sprayer 21 on the upper surface of the feed box 13B, a hot-melt adhesive ejector 51 may be installed to a lateral surface on the upstream side of the feed box 13B, relative to the rotation direction of the screw 12 (refer to FIG. 5). The hot-melt adhesive ejector 51 ejects a hot-melt adhesive H to part of the plurality of long fibers L. At this time, as a commercial product for the holt-melt adhesive ejector 51, for example, an electric hot-melt gun TE-m12 (manufactured by Sanyo Life Material) can be exemplified.

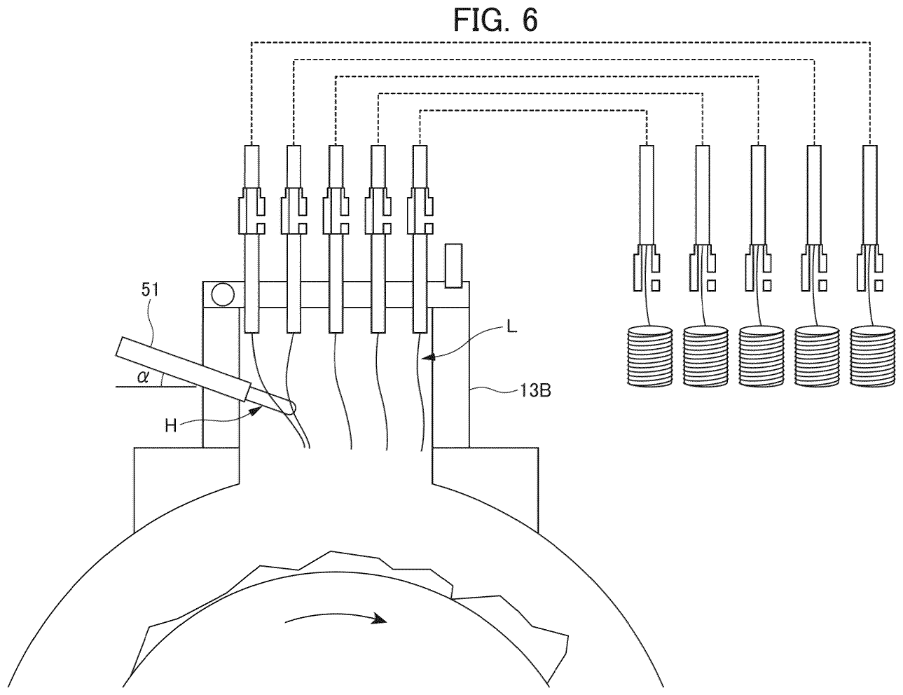

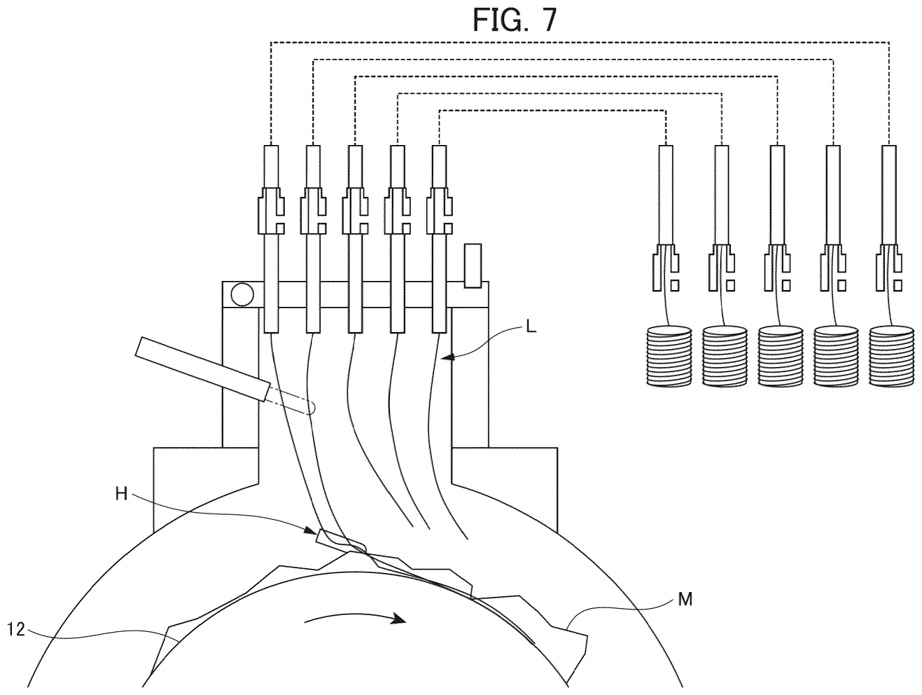

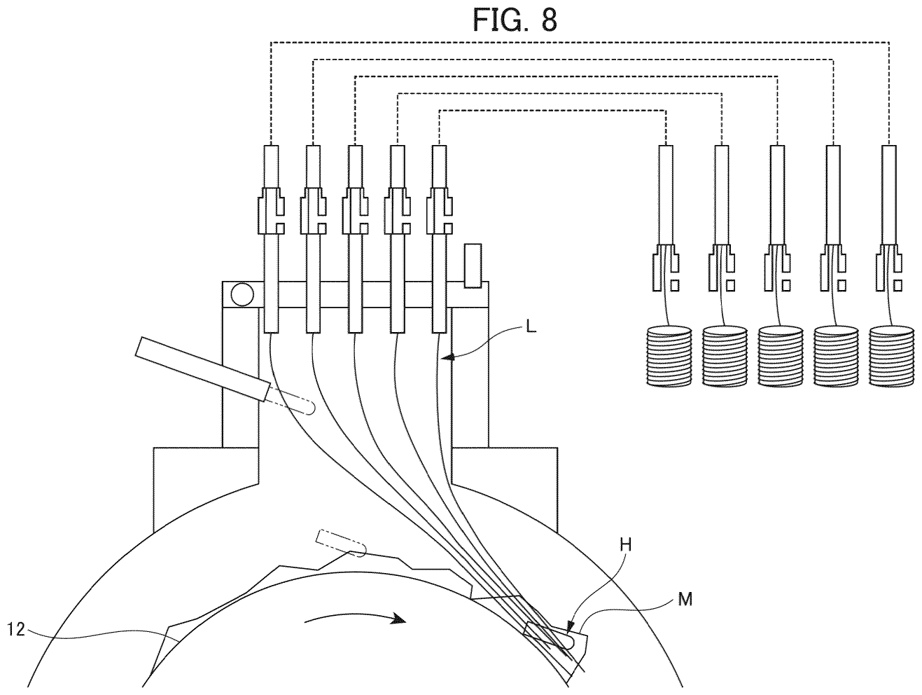

As shown in FIG. 6, when the hot-melt adhesive ejector 51 ejects the holt-melt adhesive H at an ejection angle α to a part of the plurality of long fibers L fed into the heating cylinder 11, the long fibers L adhered by the hot-melt adhesive H come into contact with the molten resin M attached to the screw 12, and resultingly start to wind around the screw 12, as shown in FIG. 7. Next, as shown in FIG. 8, the remainder of the long fibers L are led so as to come into contact with the molten resin M attached to the screw 12 by the long fibers L which have started to wind around the screw 12, and the plurality of long fibers L resultingly wind around the screw 12.

The material constituting the hot-melt adhesive H is not particularly limited so long as able to adhere part of the long fibers L; however, polyamides, polyolefins, ethylene-vinyl acetate copolymers and acrylic resins can be exemplified.

The viscosity of the hot-melt adhesive H is not particularly limited so long as capable of ejecting to part of the long fibers L; however, the viscosity is at least 1000 cps and no more than 17000 cps.

The ejection angle α is not particularly limited so long as capable of causing a part of the long fibers L to adhere; however, the ejection angle α is at least 25° and no more than 45°, for example.

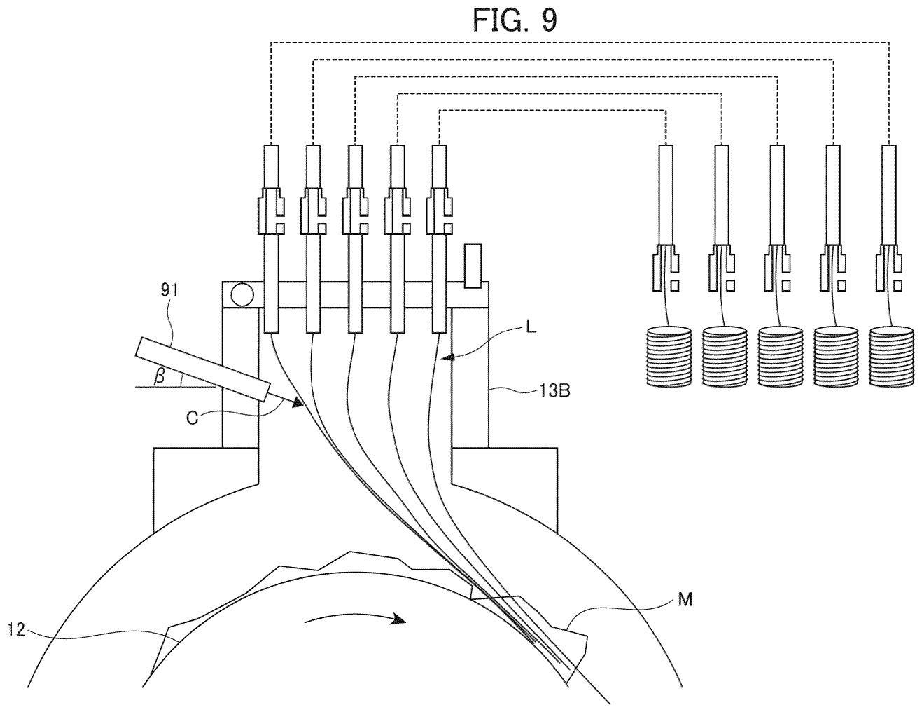

In the injection molding machine 10, instead of installing the adhesive sprayer 21 to an upper surface of the feed box 13B, a compressed air ejector 91 may be installed to a lateral surface on the upstream side of the feed box 13B, relative to the rotation direction of the screw 12 (refer to FIG. 9). The compressed air ejector 91 ejects compressed air C to the plurality of long fibers L. At this time, as a commercial product for the compressed air ejector 91, for example, a rechargeable air duster AS001GZ (manufactured by Makita) can be exemplified.

When the compressed air ejector 91 ejects the compressed air C at the ejection angle β to the plurality of long fibers L fed into the heating cylinder 11, the plurality of long fibers L are guided by the compressed air C so as to come into contact with the molten resin M attached to the screw 12, and resultingly wind around the screw 12.

The ejection angle β is not particularly limited so long as the plurality of long fibers L can come into contact with the molten resin M; however, the ejection angle β is at least 25° and no more than 45°, for example.

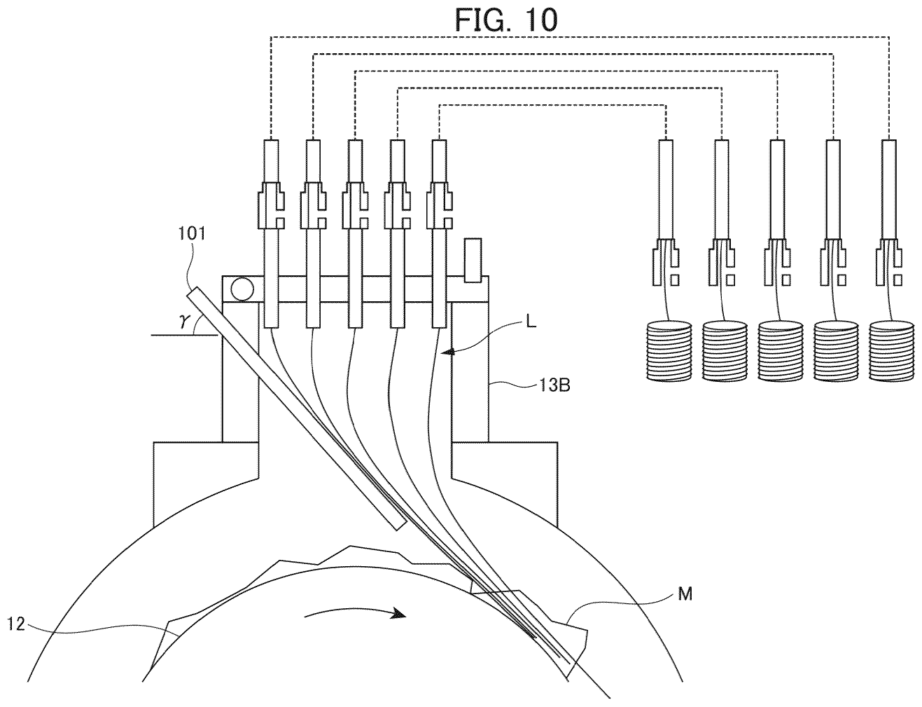

In the injection molding machine 10, instead of installing the adhesive sprayer 21 to the upper surface of the feed box 13B, a guide plate 101 may be installed at an inclination angle γ to a lateral surface of the upstream side of the feed box 13B, relative to the rotation direction of the screw 12 (refer to FIG. 10). The guide plate 101 guides the plurality of long fibers L. As the guide plate 101, a mobile-type guide plate capable of moving in the sloping direction may be used.

When the plurality of long fibers L are fed into the heating cylinder 11, the plurality of long fibers L are guided by the guide plate 101 so as to come into contact with the molten resin M attached to the screw 12, and resultingly wind around the screw 12.

The inclination angle γ is not particularly limited so long as it is possible for the plurality of long fibers L to come into contact with the molten resin M; however, the inclination angle γ is at least 15° and no more than 45°.

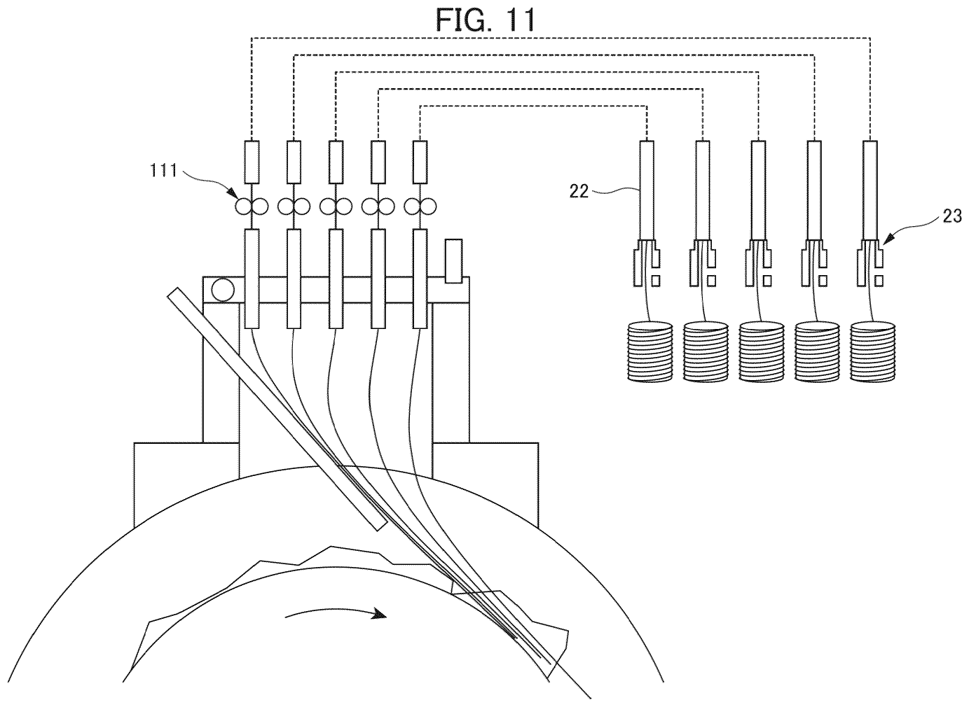

In FIG. 10, an electric rotary-type roller 111 may be installed instead of the compressed air supply 24 (refer to FIG. 11). The electric rotary-type roller 111 is a conveying member which conveys the long fibers L vertically downwards by way of rotating. It should be noted that the electric rotary-type roller 111 may be applied to the injection molding machine 10 other than that of FIG. 10.

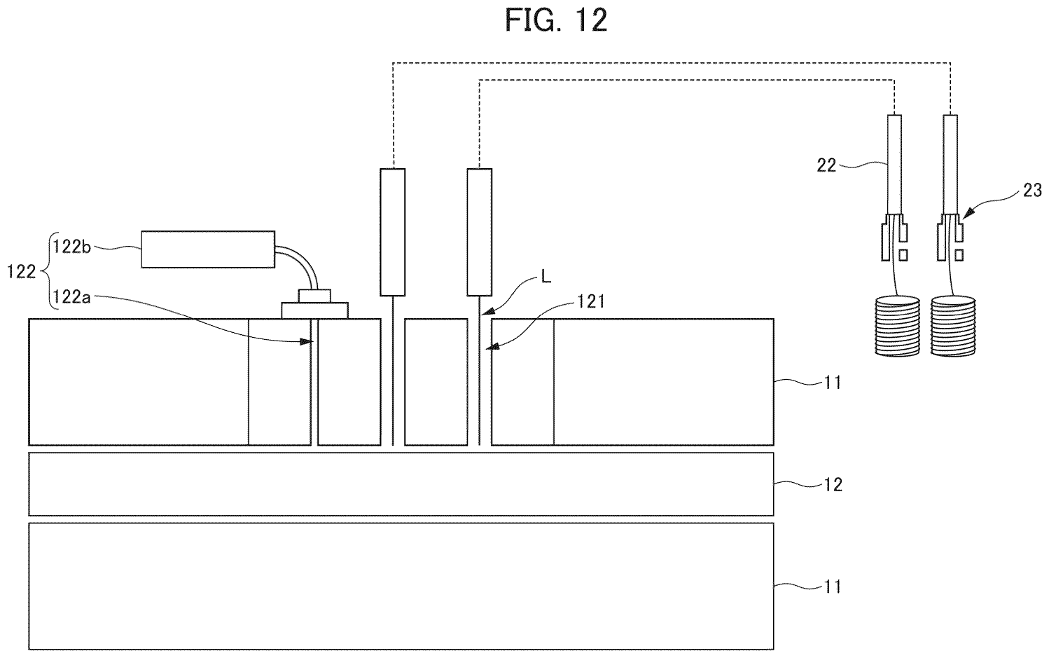

Without installing the compressed air supply 24 in the injection molding machine 10, a feed port 121 may be formed in the heating cylinder 11 instead of installing the feed box 13B thereto, and the heating cylinder 11 may be provided with a suction part 122 which assists in contact between resin melted by the heating cylinder 11 and long fibers L fed into the heating cylinder 11 (refer to FIG. 12). In the suction part 122, a suction channel 122a is formed on a downstream side of the heating cylinder 11, relative to the feed port 121, and is suctioned by a suction pump 122b. At this time, vertically upwards suctioning is done by the suction channel 122a, and vertically downwards suctioning is done by the feed port 121. For this reason, the plurality of long fibers L are suctioned from the feed port 121 towards the suction channel 122a in the space between the heating cylinder 11 and the screw 12, and thus the plurality of long fibers L come into contact with the molten resin M attached to the screw 12.

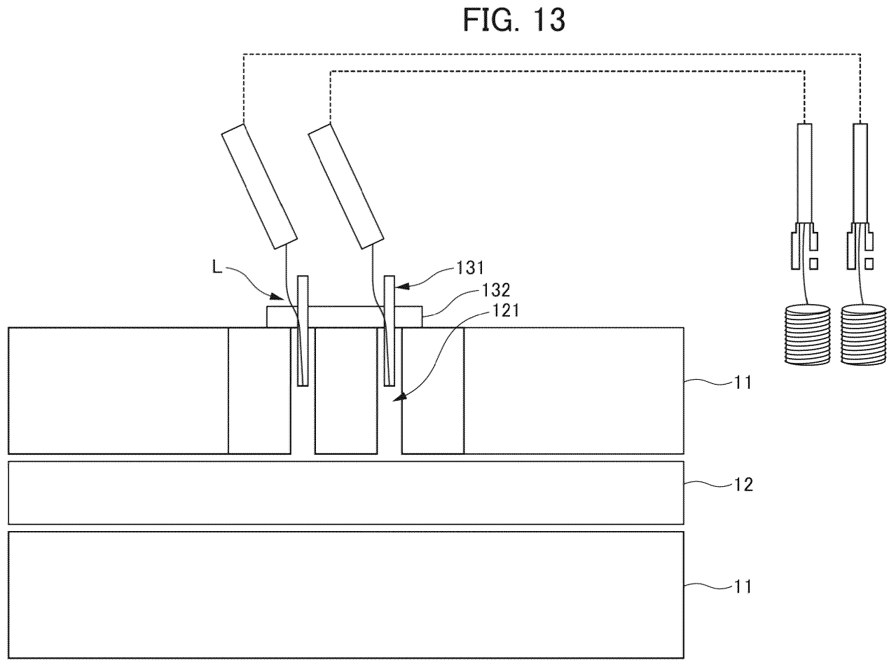

Instead of installing the suction part 122 to the heating cylinder 11 in FIG. 12, a rod-like member 131 which is able to detach the long fibers L may be installed in the feed port 121 (refer to FIG. 13). The rod-like member 131 is supported by a support member 132, and can be made to move in the vertical direction by a motor, for example. At this time, when causing the rod-like member 131 to which the long fibers L are fixed to move vertically downwards, they will come into contact with the molten resin M attached to the screw 12. On the other hand, when causing the rod-like member 131 to move vertically upwards, the long fibers having come into contact with the molten resin M are removed from the rod-like member 131.

The rod-like member 131 is not particularly limited so long as capable of detaching the long fibers L; however, a heat-resistant rubber may be provided to the tip part thereof, or a recess may be formed in the tip part thereof.

### (Injection Molding Method for Fiber-Reinforced Resin)

An injection molding method for fiber-reinforced resin of the present invention includes: a step of feeding resin into a heating cylinder into which a screw is inserted, and melting therein; a step of feeding long fibers into the heating cylinder; and a step of assisting contact between the resin melted in the heating cylinder, and the long fibers fed into the heating cylinder. Herein, the injection molding method for fiber-reinforced resin of the present embodiment can be conducted using the injection molding device for fiber-reinforced resin of the present embodiment.

Although embodiments of the present invention have been described above, the present invention is not to be limited to the above-described embodiments, and may be modified where appropriate within the scope of the gist of the present invention. For example, any of the adhesive sprayer 21, hot-melt adhesive ejector 51, compressed air ejector 91 and guide plate 101 may be used in combination.

### EXPLANATION OF REFERENCE NUMERALS

10 injection molding machine
11 heating cylinder
12 screw
13A hopper
13B feed box
14 nozzle
15 mold
21 adhesive sprayer
22 tube
23, 24 compressed air supply
51 hot-melt adhesive ejector
91 compressed air ejector
101 guide plate
111 electric rotary-type roller
121 feed port
122 suction port
121a suction channel
121c suction pump
131 rod-like member
132 support member
A adhesive
C compressed air
H hot-melt adhesive
L long fiber
M molten resin
R roving

What is claimed is:

1. An injection molding device for fiber-reinforced resin, comprising:
a heating cylinder for melting resin;
a screw which is inserted in the heating cylinder;
a resin feeder for feeding the resin into the heating cylinder;
a long fiber feeder for feeding a long fiber into the heating cylinder; and
an assister which assists in contact between the resin melted by the heating cylinder, and the long fiber fed into the heating cylinder.

2. The injection molding device for fiber-reinforced resin according to claim 1, wherein the long fiber feeder is provided to a downstream side of the resin feeder.

3. The injection molding device for fiber-reinforced resin according to claim 1, wherein the long fiber feeder feeds a plurality of the long fibers into the heating cylinder.

4. The injection molding device for fiber-reinforced resin according to claim 3, wherein the assister sprays adhesive to the plurality of the long fibers fed into the heating cylinder.

5. The injection molding device for fiber-reinforced resin according to claim 3, wherein the assister ejects a hot-melt adhesive to a part of the plurality of the long fibers fed into the heating cylinder.

6. The injection molding device for fiber-reinforced resin according to claim 1, wherein the assister ejects compressed air onto the long fiber fed into the heating cylinder.

7. The injection molding device for fiber-reinforced resin according to claim 1, wherein the assister guides the long fiber fed into the heating cylinder by a guide plate.

8. The injection molding device for fiber-reinforced resin according to claim 1, wherein the assister suctions the long fiber to assist in contact with resin melted by the heating cylinder.

9. The injection molding device for fiber-reinforced resin according to claim 1, wherein a rod-like member capable of detaching the long fiber is provided to the long fiber feeder, and
wherein the assister causes a rod-like member to which the long fiber has attached to move and assists contact with resin melted by the heating cylinder.

10. The injection molding device for fiber-reinforced resin according to claim 1, wherein a conveying member for conveying the long fiber is provided to the long fiber feeder.

11. An injection molding method for fiber-reinforced resin comprising the steps of:
feeding and melting resin into a heating cylinder in which a screw is inserted;
feeding a long fiber into the heating cylinder; and
assisting contact between resin melted by the heating cylinder and the long fiber fed into the heating cylinder.
